(19) United States
(12) Patent Application Publication
(10) Pub. No.: US 2010/0129745 A1
(43) Pub. Date: May 27, 2010

(54) ELECTROPHOTOGRAPHIC RECORDING MEDIUM

(75) Inventors: Taek-Yong Jung, Yongin-Si (KR); Chang-Woo Jung, Suwon-Si (KR)

Correspondence Address: DLA PIPER LLP US, P. O. BOX 2758, RESTON, VA, 20195, US

(73) Assignee: SAMSUNG ELECTRONICS CO., LTD., Suwon-Si (KR)

(21) Appl. No.: 12/606,407

(22) Filed: Oct. 27, 2009

(30) Foreign Application Priority Data
Nov. 25, 2008 (KR) 10-2008-0117638

(51) Int. Cl. G03G 5/06

(52) U.S. Cl. 430/96; 430/56; 430/127

(57) ABSTRACT

An electrophotographic recording medium is disclosed. The electrophotographic recording medium can include a base layer acting as the substrate, a undercoating layer formed on a surface of the base layer and a toner fixing layer formed on the undercoating layer. The undercoating layer may include one or more resins selected from a group consisting of an acryl resin, a polyurethane resin, a vinyl resin and a polyol resin. The electrophotographic recording medium disclosed herein may advantageously exhibit curling preventive characteristics and improved smoothness and glossiness.

### CROSS-REFERENCE TO RELATED APPLICATIONS

This application claims the benefit under 35 U.S.C. §119 (a) of Korean Patent Application No. 10-2008-0117638, filed on Nov. 25, 2008, in the Korean Intellectual Property Office, the entire disclosure of which is hereby incorporated by reference.

### TECHNICAL FIELD

The present disclosure relates generally to an electrophotographic recording medium, and, more particularly, to an electrophotographic recording medium that has improved smoothness, glossiness and/or print glossiness, and with which curling during printing may be reduced.

### BACKGROUND OF RELATED ART

As computer application technologies have become widespread in recent years, various types of documents and images are being produced using computers, and are being printed in tangible form using, e.g., printers. Such printers include, for example, dot-matrix impact printers, laser printers, thermal printers, inkjet printers, and the like. Among these printers, laser printers, which use a laser beam in printing (also referred to as electrophotography), and inkjet printers are widely used by general consumers because of their high printing speeds and their ability to print high-resolution images.

Electrophotography, when used in copiers and/or printers, generally has several imaging processing steps. A photoconductive drum or belt is charged to a constant potential in a dark environment. A Laser beam is irradiated on the charged surface of the photoconductive drum or belt to form electrostatic latent images thereon. The electrostatic latent images are developed with developer, e.g., charged toner, where the toner is transferred onto the electrostatic latent images formed on the photoconductive drum or belt by, e.g., electrostatic force, to form toner images.

A recording medium is made to move past the photoconductive drum or the belt so that the toner image is transferred therefrom onto the recording medium. The recording medium may be conductive, at least to some extent, in order for the toner images to be transferred thereto by electrostatic force. The toner image transferred to the recording medium is fixed thereon by a hot fusing process in which heat and pressure are applied to the recording medium typically with the use of one or more rollers.

Electrophotographic printers employing the electrophotography process generally described above can use various recording media, including paper. With improvements in the performance of toner that is used in electrophotographic printers, and with enhancements in the transferring and fixing technologies, recording media suitable for use in electrophotographic printers have become more widely available. For example, highly glossy recording medium is available for use with inkjet printers.

Generally, a sheet of paper or printing medium suitable for use with electrophotographic printers is formed by coating a toner fixing layer on one side or on both sides of a base layer. More particularly, a filler and a binder resin are mixed in a suitable ratio to prepare a composition used to form the toner fixing layer. The composition is then coated on the base layer. Such a toner fixing layer enables a printing medium used for electrophotographic printers to have excellent smoothness and glossiness compared to ordinary paper. The smoothness and the glossiness of the recording media may affect the print glossiness during printing, and could significantly influence the print quality.

To increase the smoothness and the glossiness of a conventional electrophotographic recording medium, an inorganic material having small-sized particles can be used or attempts to improve the conditions, e.g., temperature and pressure conditions, during the calendaring process can be made. However, when an inorganic material having small-sized particles is used in a conventional electrophotographic recording medium, the cost may become disadvantageously high and/or it may be difficult to treat the inorganic material due to the small particle size. When, an inorganic material of a large particle size is used, on the other hand, a calendaring process may be required.

During the calendaring process, the temperature and pressure are adjusted to achieve a varying degree of thickness, smoothness and/or glossiness of recording media. As the temperature and the pressure increase, the thickness of the recording media decreases while the smoothness and the glossiness of the recording media may improve. Excessively high temperature and/or pressure, however, can be a source of problems in the manufacturing of the recording media. An inappropriate choice of the base layer can also influence the toner fixing layer. It may thus be generally advantageous to apply suitably low temperature and/or pressure.

Because an electrophotographic printing employs heat, the recording medium can become curled during such printing. A recording medium can be curled during printing due to a difference in some characteristics between the two face surfaces of the recording medium. The curling phenomenon can also be related to the amount of moisture contained in the recording medium.

When a large amount of toner is transferred to a recording medium during the printing of some high resolution images, e.g., photographic images, a larger amount of heat may also need to be applied to the recording medium because of the increase in time for fixing the toner to the recording medium. The increased amount of heat may result in the increase in the likelihood of curling of the recording medium. With high-resolution images, such as photographs, being printed more regularly, controlling the curling phenomenon is becoming an important consideration. As one conventional attempt to address the curling problem, a double-side coating is typically used to reduce the difference between the sides of a recording medium. A double-side coating, however, is not panacea as it results in an increase in the manufacturing costs, and still may not address some problems, e.g., when a large amount of toner is being fixed or when certain other fixing conditions occur.

Moreover, while electrophotographic printers employ toner that includes pigments that are better in lightfastness relative to dye used in toner employed by inkjet printers or dye sublimation printers, as photographs are being printed in greater frequently, and as desire to preserve the images for longer period of time thus increases, the lightfastness is becoming an increasingly important consideration even for electrophotographic printers whereas the lightfastness was traditionally of concern primarily for an inkjet printer or a dye sublimation printer.

There is thus a need for recording media for use with an electrophotographic printer with improved glossiness and/or lightfastness, and with which the occurrences of curling may be reduced.

### SUMMARY OF THE DISCLOSURE

According to an aspect of the present disclosure, there is provided an electrophotographic recording medium that can include a base layer, an undercoating layer covering a surface of the base layer and a toner fixing layer covering the undercoating layer. The toner fixing layer may define an outer surface of the electrophotographic recording medium. The undercoating layer may comprise one or more resins selected from a group consisting of an acryl resin, a polyurethane resin, a vinyl resin and a polyol resin.

The undercoating layer may further comprise a hardener.

The toner fixing layer may include a filler and a binder resin.

The filler of the toner fixing layer may comprise at least one selected from a group consisting of calcium carbonate, alumina, silica and titanium oxide, and may have a mean volume diameter in a range of about 0.05 microns (μm) to about 2.5 μm.

The binder resin of the toner fixing layer may comprise at least one selected from a group consisting of a polyvinyl alcohol, a polyvinyl pyrrolidone, a cellulose, a gelatin, a polyethylene oxide, an acryl, a polyester, a polyurethane, a latex and a quaternary ammonium-based copolymer.

The toner fixing layer may include the binder resin in an amount that ranges from about 5 to about 100 parts by weight based on 100 parts by weight of total solids in the toner fixing layer.

The undercoating layer may have a thickness in a range of about 0.1 μm to about 5

The undercoating layer may comprise about 80 to about 90 parts by weight of the resin based on 100 parts by weight of total solids in the undercoating layer and about 10 to about 20 parts by weight of the hardener based on 100 parts by weight of total solids in the undercoating layer.

The undercoating layer may further include an additive.

For example, the additive may comprise a whitening agent.

The base layer may have a thickness in a range of about 50 μm to about 300 μm.

According to another aspect of the present disclosure, a method of manufacturing a recording medium may comprise the steps of providing a substrate, preparing a coating material, coating at least one surface of the substrate with the coating material so as to form a undercoating layer and coating the undercoating layer with a composition that comprises a filler and binder resin to form a toner fixing layer covering the undercoating layer. The prepared coating material may comprise one or more resins selected from a group consisting of an acryl resin, a polyurethane resin, a vinyl resin and a polyol resin.

The coating material may comprise about 90 parts by weight of a polyol and about 10 parts by weight of a polyisocyanate.

Alternatively, the coating material may comprise an acrylic-based primer.

The coating material may further comprise a whitening agent.

The step of coating the coating material may comprise coating the coating material in an amount that results in the undercoating layer having a thickness in a range of about 0.1 μm to about 5 μm.

The composition may comprise about 2 parts by weight of a polyvinyl alcohol, about 8 parts by weight of a latex, and about 90 parts by weight of a calcium carbonate.

The coating material may comprise about 95 parts by weight of a polyurethane and about 5 parts by weight of a polyurethane hardener.

The coating material may alternatively comprise about 95 parts by weight of a polyurethane, about 4.5 parts by weight of a polyurethane hardener, and about 0.5 parts by weight of a whitening agent.

The substrate may have a thickness in a range of about 50 μm to about 300 μm.

### BRIEF DESCRIPTION OF THE DRAWINGS

Various aspects of the present disclosure will become apparent and more readily appreciated from the following description of the embodiments, taken in conjunction with the accompanying drawings, in which:

FIG. 1 is a cross-sectional view of an electrophotographic recording medium according to an embodiment of the present disclosure.

### DETAILED DESCRIPTION OF SEVERAL EMBODIMENTS

Several embodiments of the present disclosure are described below in detail with reference to the accompanying drawings. While certain descriptions of the embodiments, such as details of construction, elements, features, configurations and/or arrangements, are provided by way of examples in order to assist in a comprehensive understanding of the embodiments, those of ordinary skill in the art will recognize that various changes of and modifications to the embodiments can be made without departing from the scope and spirit of the aspects of the disclosure. Also, well-known functions or constructions may be omitted to provide a clear and concise description of the embodiments without obscuring the same in unnecessary details.

According to an aspect of the present disclosure, an electrophotographic recording medium may include a base layer, a toner fixing layer and an undercoating layer. The toner fixing layer can be coated on one surface of the base layer whereas the undercoating layer can be formed between the base layer and the toner fixing layer to, for example, mitigate curling of the electrophotographic recording medium.

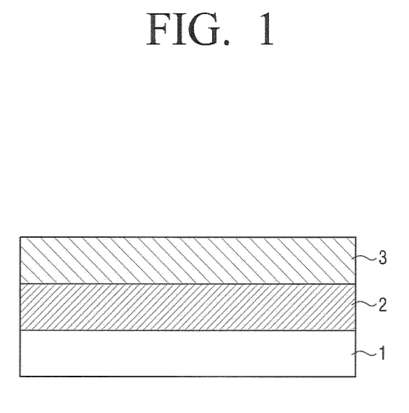

FIG. 1 is a cross-sectional view of an electrophotographic recording medium according to an embodiment of the present disclosure. The electrophotographic recording medium shown in FIG. 1 can include a base layer 1, an undercoating layer 2 and a toner fixing layer 3.

The base layer 1 can be substantially the same as a base layer of a known conventional electrophotographic recording medium, and need not be limited to any particular base layer. Accordingly, any base layer that acts as a substrate, which can, for example, withstand the fixing temperature and that can satisfy certain requirements, such as smoothness, whiteness, friction, antistatic property, fixability, or the like, suitable for the purpose of the particular use or application, can be used as the base layer 1.

The base layer 1 can be, for example, a paper support, a synthetic paper (e.g., polyolefins, polystyrenes, or the like), a woodfree paper, an art paper, a coated paper, a mixed paper prepared from a natural pulp and a synthetic resin pulp (e.g., polyethylene or the like), a baryta paper, a synthetic resin, an impregnated paper, an emulsion impregnated paper, a synthetic rubber latex impregnated paper, a paperboard, a cellulose tissue paper, or the like. The base layer 1 can also be, for example, a plastic film support such as a polyolefin, a polyvinyl chloride, a polyethylene terephthalate, a polystyrene, a polymethacrylate, a polycarbonate, or the like.

The base layer 1 can also be, for example, a white opaque film prepared by adding a white pigment or filler to the synthetic resin, or a foam sheet prepared by foaming the synthetic resin. The base layer 1 can be of a single type, or can be a laminated structure having two or more types of materials. For example, the base layer can be a laminate of cellulose tissue paper and synthetic paper or a laminate of cellulose tissue paper and a plastic film.

The thickness of the base layer 1 can be set appropriately based on the particular application for the electrophotographic recording medium. The thickness of the base layer 1 can typically be in the range of about 50 microns (μm) to about 300 μm. In some embodiments, the thickness of the base layer 1 can desirably be in the range of about 70 μm to about 200 μm. For example, when the thickness of the base layer 1 is less than 50 μm, the electrophotographic recording medium can curl during printing. On the other hand, when the thickness of the base layer 1 is greater than 300 μm, problems in the feeding of the recording medium may occur.

The undercoating layer 2 can be used to strengthen adhesion between the base layer 1 and the toner fixing layer 3. An improved adhesiveness of the toner fixing layer 3 to the base layer 1 can also prevent the electrophotographic medium from curling. As a result, while in some embodiments it could still be employed, double-side coating may not be necessary.

Generally, when coating is performed using a composition containing a large amount of a filler, if a paper support is used instead of films having high glossiness and high smoothness, glossiness can be significantly reduced. However, according to an embodiment of the present disclosure, a resin capable of exhibiting high glossiness can be used as a resin contained in the coating material composition for the undercoating layer 2. Thus, it may be possible to provide a recording medium with high glossiness regardless of the material used for the base layer 1.

Additionally, the undercoating layer 2 can include an additive. For example, an additive, such as an ultraviolet blocking agent or an antioxidant, can be added to the undercoating layer 2 to improve the possible susceptibility of the base layer material to light, thereby possibly increasing the lightfastness of the recording medium.

To increase the whiteness of a conventional recording medium, a whitening agent or dye can be added to the toner fixing layer 3, which may cause yellowing of the printed portion or of the unprinted portion of such conventional recording medium. When the whitening agent or dye is added as an additive to the undercoating layer 2 rather than to the toner fixing layer 3, its effect on the external appearance can be reduced, and may thus also result in an improvement in the lightfastness.

The resin in the undercoating layer 2 can be, but need not be limited to, a polyol-based resin, a polyurethane-based resin, an acryl-based resin, a vinyl resin, or the like.

The undercoating layer 2 can further include a hardener. The hardener can be, for example, a compound such as polyisocyanate, or other suitable hardener.

The undercoating layer 2 can also include other additives, such as, for example, an ultraviolet absorber, an antioxidant, a whitening agent, a fluorescent dye, talc, titanium oxide, a lubricant, or a surfactant, or a combination of two or more thereof.

The undercoating layer 2 can be used on the base layer 1 regardless of the type of base layer 1 being used. As described above, the base layer 1 can be synthetic paper, a woodfree paper, an art paper, a coated paper, a baryta paper, or a synthetic resin, for example. The base layer 1 can also be, for example, a paper support, such as an emulsion impregnated paper, a synthetic rubber latex impregnated paper, a paperboard, a cellulose tissue paper, or the like. Moreover, the base layer 1 can be, for example, a plastic film support, such as a polyolefin, a polyvinyl chloride, a polyethylene terephthalate, a polystyrene, a polymethacrylate, a polycarbonate, or the like.

One or more material contained in the undercoating layer 2 can exhibit miscibility with a filler and/or a binder resin contained in the toner fixing layer 3.

The undercoating layer 2 can desirably have a thickness of about 0.1 μm to about 5 μm, and preferably about 0.5 μm to about 2 μm. When the thickness of the undercoating layer 2 is less than 0.1 μm, the curling prevention effect and coating uniformity can be reduced. When the thickness of the undercoating layer 2 is greater than about 5 μm, image clarity may degrade or cracks may occur during coating.

To form the undercoating layer 2, a resin, a hardener and additives can be mixed to prepare a composition used to coat the undercoating layer 2. Once prepared, the composition can be coated on the base layer 1 to form the undercoating layer 2.

Various processes for coating the undercoating layer 2 can be applied, and, in particular, a gravure coating process may typically be used.

The toner fixing layer 3 can include a filler and a binder resin that can be used in a toner fixing layer of any conventional electrophotographic recording medium, and need not be limited to any particular material or materials. The filler can be, for example, an inorganic filler or an organic filler.

An inorganic filler that can be used according to embodiments of the present disclosure can be, for example, a kaolin clay, alumina, silica, calcium carbonate, talc, aluminum hydroxide, satin white, titanium dioxide, calcined clay, zinc oxide, barium sulfate, or the like. An organic filler that can be used according to embodiments of the present disclosure can be, for example, a styrene-based resin (e.g., polystyrene, polymethylstyrene, or the like), an acryl-based resin (e.g., polymethacrylic acid methyl, polyacrylonitrile, or the like), a vinyl chloride, a polycarbonate or the like, or any of various combinations thereof mixed in a certain ratio.

Among the fillers described above, calcium carbonate, silica or alumina can be the ones that may be typically used.

The mean volume diameter of particles of the filler can be in the range of about 0.05 μm to about 2.5 μm, and may preferably be in the range of about 0.1 μm to about 1.0 μm. When the mean volume diameter is less than 0.05 μm, such filler may be disadvantageous in terms of its costs and in terms of the difficulty in processing the filler because of dust generated when forming the composition containing the filler. On the other hand, when the mean volume diameter is greater than 2.5 μm, the glossiness can deteriorate.

The binder resin can include one or more of a polyvinyl alcohol, a polyvinyl pyrrolidone, a methyl cellulose, a hydroxypropylmethyl cellulose, a gelatin, a polyethylene oxide, an acryl-based polymer, a polyester, a polyurethane, an epoxy resin, a latex and a quaternary ammonium-based copolymer. Desirably, the latex may include a styrene-butadiene latex, a styrene-butadiene-acrylonitrile latex, an acryl-based latex, or the like.

An amount of the binder resin can be in the range of about 5 to about 100 parts by weight, or may desirably be in the range of about 10 to about 75 parts by weight based on 100 parts by weight of the filler contained in the toner fixing layer 3. When the amount of the binder resin is less than 5 parts by weight based on 100 parts by weight of the filler contained in the toner fixing layer 3, paper powder can be generated. On the other hand, when the amount of the binder resin is greater than 100 parts, paper feeding problems, such as jamming or multiple sheets feeding, can occur.

The toner fixing layer 3 can further include various additives to improve the stability of the printed image or of the toner fixing layer 3 itself and/or to increase processability during the manufacture of the electrophotographic recording medium. The use of additives may complement the properties of the electrophotographic recording medium. Examples of additives can include, for example, an antistatic agent, a hardener, a pH adjuster, an ultraviolet absorber, an antioxidant, an antifoaming agent, a leveling agent, a lubricant, a surfactant, an anticorrosion agent, or the like.

The total amount of the additives contained in the toner fixing layer 3 can be in the range of about 0.1 to about 10 parts by weight, or may desirably be in the range of about 0.1 to about 5 parts by weight based on 100 parts by weight of the filler contained in the toner fixing layer 3. When the total amount of the additives is less than 0.1 part by weight based on 100 parts by weight of the filler, the effect of the additives may be insignificant. Alternatively, when the total amount of the additives is greater than 10 parts by weight, the print quality and/or the coating properties can be degraded.

The components used to form the toner fixing layer 3 can be mixed with a solvent to prepare a composition. The prepared composition can be coated on the undercoating layer 2 so that the toner fixing layer 3 is formed. The solvent used to coat the composition for the toner fixing layer 3 can be water when consideration is given to the environmental concerns and to issues of workability. The solvent, however, need not be so limited. As alternatives to a water based solvent, the solvent can be, for example, a ketone, a glycol ether, an alcohol, a methyl cellosolve, an ethyl cellosolve, a dimethyl formamide, a dimethyl sulfoxide, or the like. In particular, the ketone can be acetone or a methyl ethyl ketone, the glycol ether can be a diethylene glycol or a diethylene glycol monobutyl ether, and the alcohol can be methanol, ethanol, butanol, isopropanol, or the like. The amount of solvent can be adjusted so that an amount of solids contained in the composition for the toner fixing layer 3 can be in the range of about 5 to about 80 parts by weight, or can desirably be in the range of about 20 to about 70 parts by weight. When the amount of the solvent is adjusted so that the amount of the solids is less than 5 parts by weight, it may be difficult to dry the composition for the toner fixing layer 3 during and/or after the coating process. Alternatively, when the amount of the solvent is adjusted so that the amount of the solids is greater than 80 parts by weight, the viscosity of the composition for the toner fixing layer 3 can become too high and cracks may occur or unwanted defects may be generated in the toner fixing layer 3, resulting in poor surface coating properties.

When the toner fixing layer 3 is formed to a certain thickness, there may not be a change in the fixability even when the toner fixing layer 3 is made thicker. Therefore, it may not be necessary to form a thick toner fixing layer. The thickness of the toner fixing layer 3 may be in the range of about 5 μm to about 40 μm, or may desirably be in the range of about 10 μm to about 30 μm. When the thickness of the toner fixing layer 3 is less than 5 μm, the toner fixing layer 3 may not properly perform its intended function. Alternatively, when the thickness of the toner fixing layer 3 is greater than 40 μm, costs may be high and it may be difficult to dry the composition for the toner fixing layer 3 during and/or after coating. The toner fixing layer 3 can have a laminated structure including two or more layers when appropriate.

The electrophotographic recording medium formed as described above may be utilized by various printing devices that use electrophotographic recording process, such as, for example, a laser printer, a facsimile machine, a copier, or the like.

To further illustrate various aspects of the present disclosure, several specific examples of electrophotographic recording media along with an empirical observations of the same are described below. It should be noted that the following examples are not intended to, and indeed do not, limit the scope of the present disclosure.

### EXAMPLES

### Example 1

In this example, a coating material for the undercoating layer is applied onto art paper (Hansol Paper Co., Ltd., Korea) having a basis weight of 140 grams-per-square meter (g/m²) using a bar coater. The coating material is dried at 100 degrees Celsius (° C.) for 1 minute to form an undercoating layer having a thickness of about 1 μm. The prepared composition used for the undercoating layer in this example is the following:

| | |
|---|---|
| Polyol (DL-505SA-1, Shinsung Chemical Ind. | 90 parts by weight |
| Co. Ltd., Korea) | |
| Polyisocyanate (Shinsung Chemical Ind. Co. Ltd., | 10 parts by weight |
| Korea) | |

A coating material for the toner fixing layer is applied using a bar coater to the art paper on which the undercoating layer has been formed, and is dried in an oven at 110° C. for 3 minutes to obtain a toner fixing layer having a thickness of about 20 μm. The composition used to form the toner fixing layer is the following:

| | |
|---|---|
| Polyvinyl alcohol (F-05, DC Chemical Co., Ltd., | 2 parts by weight |
| Korea) | |
| Latex (SAV-4720, Synature, Inc., Korea) | 8 parts by weight |
| Calcium carbonate (COVERCARB 75, OMYA | 90 parts by weight |
| Korea Inc., Korea) | |

### Example 2

In this example, an electrophotographic recording medium is prepared in substantially the same manner as in Example 1, with a difference being that in this example the composition for coating the toner fixing layer is prepared with the following components:

| | |
|---|---|
| Polyvinyl alcohol (F-05, DC Chemical Co., Ltd., | 2 parts by weight |
| Korea) | |
| Latex (SAV-4720, Synature, Inc., Korea) | 8 parts by weight |
| Silica sol (ST-PS-M, Nissan Chemical Industries | 89 parts by weight |
| Ltd., Japan) | |
| Fixing agent (HANWET HF-59, | 0.5 parts by weight |
| Hansol Chemical Co., Ltd., Korea) | |
| Glyoxal | 0.5 parts by weight |

### Example 3

In this example, an electrophotographic recording medium is prepared in substantially the same manner as in Example 1, with a difference being that in this example the composition for coating the toner fixing layer is prepared with the following components:

| | |
|---|---|
| Polyvinyl alcohol (F-05, DC Chemical Co., Ltd., | 2 parts by weight |
| Korea) | |
| Latex (SAV-4720, Synature, Inc., Korea) | 8 parts by weight |
| Alumina sol (AS-520, Nissan Chemical Industries | 89 parts by weight |
| Ltd., Japan) | |
| Glyoxal | 1 parts by weight |

### Example 4

In this example, an electrophotographic recording medium is prepared in substantially the same manner as in Example 1, with a difference being that in this example the composition for coating the undercoating layer is prepared with the following components:

| | |
|---|---|
| Polyurethane (GPP-S506, | 95 parts by weight |
| Shinsung Chemical Ind. Co. Ltd., Korea) | |
| Polyurethane hardener (Shinsung Chemical Ind. Co. | 5 parts by weight |
| Ltd., Korea) | |

### Example 5

In this example, an electrophotographic recording medium is prepared in substantially the same manner as in Example 1, with a difference being that in this example the composition for coating the undercoating layer is prepared with the following components:

| | |
|---|---|
| Acrylic-based primer (Sam Young Ink & | 100 parts by weight |
| Paint MFG. Co., LTD., Korea) | |

### Example 6

In this example, an electrophotographic recording medium is prepared in substantially the same manner as in Example 1, with a difference being that in this example the composition for coating the undercoating layer is prepared with the following components:

| | |
|---|---|
| Polyurethane (GPP-S506, | 95 parts by weight |
| Shinsung Chemical Ind. Co. Ltd., Korea) | |
| Polyurethane hardener (Shinsung Chemical Ind. | 4.5 parts by weight |
| Co. Ltd., Korea) | |
| Whitening agent (UBITEX-OB, Ciba, Germany) | 0.5 parts by weight |

### Example 7

In this example, an electrophotographic recording medium is prepared in substantially the same manner as in Example 1, with a difference being that in this example the composition for coating the undercoating layer is prepared with the following components:

| | |
|---|---|
| Polyurethane (GPP-S506, | ~95 parts by weight |
| Shinsung Chemical Ind. Co. Ltd., Korea) | |
| Polyurethane hardener (Shinsung Chemical Ind. Co. | ~5 parts by weight |
| Ltd., Korea) | |
| Whitening agent (UBITEX-OB, Ciba, Germany) | 0.5 parts by weight |
| Titanium oxide (WD 2002, Elementis Specialties, | 0.5 parts by weight |
| Inc., U.S.A.) | |

### Comparative Example 1

In this example, an electrophotographic recording medium is prepared in substantially the same manner as in Example 1, with a difference being that in this example an undercoating layer is not formed.

### Comparative Example 2

In this example, an electrophotographic recording medium is prepared in substantially the same manner as in Example 2, with a difference being that in this example an undercoating layer is not formed.

### Comparative Example 3

In this example, an electrophotographic recording medium is prepared in substantially the same manner as in Example 3, with a difference being that in this example an undercoating layer is not formed.

### Comparative Example 4

In this example, an electrophotographic recording medium is prepared in substantially the same manner as in Example 1, with differences being that in this example an undercoating layer is not formed and that a calendaring is performed at 60° C. and 500 pounds-per-square inch (psi) using a 753 super calender (Beloit Wheeler Company) after coating and drying the toner fixing layer.

### Comparative Example 5

In this example, an electrophotographic recording medium is prepared in substantially the same manner as in Example 1, with a difference being that in this example the undercoating layer has a thickness of about 6 μm.

### Comparative Example 6

In this example, an electrophotographic recording medium is prepared in substantially the same manner as in Example 1, with a difference being that in this example the composition for coating the toner fixing layer is prepared with the following components:

| | |
|---|---|
| Polyvinyl alcohol (F-05, DC Chemical Co., Ltd., | 2 parts by weight |
| Korea) | |
| Latex (SAV-4720, Synature, Inc., Korea) | 8 parts by weight |
| Calcium carbonate (COVERCARB 75, OMYA | 89 parts by weight |
| Korea Inc., Korea) | |
| Whitening agent (Tinopal-IJT, Ciba, Germany) | 1 parts by weight |

### Test and Results

1. Tests for Smoothness, Whiteness and Glossiness

The test results for smoothness, whiteness, and glossiness of the electrophotographic recording media prepared in Examples 1 to 7 and Comparative Examples 1 to 6 are listed below in Table 1.

TABLE 1
Comparison of Smoothness, Whiteness and Glossiness

| | | | Glossiness*** | |
|---|---|---|---|---|
| | Smoothness* | Whiteness** | 60° | 85° |
| Example 1 | 0.50 μm | 82 | 35 | 80 |
| Example 2 | 0.35 μm | 81 | 40 | 85 |
| Example 3 | 0.20 μm | 85 | 45 | 90 |
| Example 4 | 0.55 μm | 83 | 35 | 80 |
| Example 5 | 0.45 μm | 84 | 40 | 80 |
| Example 6 | 0.50 μm | 88 | 35 | 80 |
| Example 7 | 0.55 μm | 90 | 35 | 80 |
| Comparative Example 1 | 1.50 μm | 83 | 10 | 35 |
| Comparative Example 2 | 1.00 μm | 80 | 20 | 50 |
| Comparative Example 3 | 0.80 μm | 82 | 30 | 70 |
| Comparative Example 4 | 0.75 μm | 83 | 35 | 75 |
| Comparative Example 5 | 0.45 μm | 82 | 40 | 80 |
| Comparative Example 6 | 0.50 μm | 90 | 35 | 75 |

*Smoothness: A roughness tester TR-100 (available from Time High Technology, Ltd., Beijing, China) is used to measure the smoothness. Lower figure indicates higher smoothness.
**Whiteness: A Brightimeter Micro S-5 (available from Technidyne Corporation, IN, U.S.A.) is used to measure the whiteness. Higher figure indicates higher whiteness.
***Glossiness: A Microgloss Ref-160 (available from Sheen Instruments Ltd., United Kingdom) is used to measure the glossiness. Higher figure indicates higher degree of glossiness.

It can be observed from the testing results summarized in Table 1 that when an undercoating layer is interposed between the toner fixing layer and the base layer (as is the case in Examples 1 to 7 and Comparative Examples 5 and 6), the electrophotographic recording media can exhibit good smoothness. However, without an undercoating layer, even when a component with small-sized particles, such as silica sol or alumina sol, is used to form the toner fixing layer, it may be difficult to obtain the desired smoothness depending on the particular type of base layer being used.

The electrophotographic recording media prepared in Examples 1 to 7 and Comparative Examples 5 and 6 are observed to exhibit good glossiness as well.

Accordingly, it may be desirable to form an undercoating layer containing a high glossy resin so that an electrophotographic recording medium may have very good smoothness and glossiness regardless of the type of base layer used.

Additionally, the electrophotographic recording medium prepared in Comparative Example 6, in which a whitening agent is added to the toner fixing layer, exhibits similar whiteness to the electrophotographic recording media prepared in Examples 6 and 7, in which a whitening agent is added to the undercoating layer.

2. Tests for Print Glossiness, Optical Density and Curling Degree

Test results for print glossiness, optical density and curling degree of the electrophotographic recording media prepared in Examples 1 to 7 and Comparative Examples 1 to 6 are listed below in Table 2.

TABLE 2
Comparison of Print Glossiness, Optical Density and Curling Degree

| | Print | | Optical | | |
|---|---|---|---|---|---|
| | Glossiness* | | Density** | | Curling |
| | 60° | 85° | Magenta | Black | Degree*** |
| Example 1 | 20 | 60 | 0.80 | 1.62 | 0.5 mm |
| Example 2 | 25 | 70 | 0.78 | 1.57 | 1.0 mm |
| Example 3 | 30 | 75 | 0.82 | 1.60 | 0.5 mm |
| Example 4 | 15 | 60 | 0.81 | 1.59 | 1.0 mm |
| Example 5 | 25 | 65 | 0.78 | 1.62 | 0.5 mm |
| Example 6 | 20 | 60 | 0.81 | 1.60 | 1.0 mm |
| Example 7 | 25 | 60 | 0.83 | 1.58 | 1.5 mm |
| Comparative Example 1 | 10 | 40 | 0.75 | 1.55 | 5.0 mm |
| Comparative Example 2 | 15 | 45 | 0.79 | 1.60 | 6.5 mm |
| Comparative Example 3 | 20 | 50 | 0.78 | 1.62 | 5.5 mm |
| Comparative Example 4 | 20 | 55 | 0.78 | 1.58 | 5.5 mm |
| Comparative Example 5 | 20 | 60 | 0.72 | 1.50 | 0.5 mm |
| Comparative Example 6 | 20 | 60 | 0.81 | 1.62 | 1.0 mm |

*Print Glossiness: A black block is printed on the coated paper using an HP color LaserJet 2600 printer (available from Hewlett Packard Co., U.S.A.), and the print glossiness of the printed portion of the coated paper is measured using a Microgloss Ref-160 of Sheen Instruments Ltd.. Higher figure indicates higher print glossiness. The print glossiness is measured at a incidence angle of 60° and at an incidence angle of 85°.
**Optical Density: Magenta and black images are printed using the same HP color LaserJet 2600 printer that is used to measure the print glossiness above, and the optical density thereof is measured using a SpectroEye spectrophotometer (available from GretagMacbeth, U.S.A.). Higher figure indicates higher clarity.
***Curling Degree: A black block is printed on the entire surface of the coated paper using a laser printer CLP 300 (Samsung Electronics, Korea). After 3 minutes have elapsed, heights from the bottom to four vertexes of the sheets of paper are measured and the average of the measured heights is taken.

The results of Table 2 show that the print glossiness can be proportional to the smoothness and whiteness, and that the print glossiness of those electrophotographic recording media in which the undercoating layers are formed can be relatively higher than the print glossiness of the electrophotographic recording media in which no undercoating layer is formed.

Additionally, when the calendering process is performed on the electrophotographic recording medium of Comparative Example 4, in which no undercoating layer is formed, the print glossiness can be very good. There may not be a significant difference in print glossiness between the electrophotographic recording media having the undercoating layers and the electrophotographic recording media having no undercoating layer, but to which calendering process had been performed.

When the undercoating layer is thick, as is the case in Comparative Example 5, the optical density may be somewhat reduced. Therefore, properly controlling the thickness of the undercoating layer may be necessary.

Based on the results shown in Table 2, when no undercoating layer is formed between a toner fixing layer and a base layer as illustrated in Comparative Examples 1 to 4, the electrophotographic recording media curled severely compared to when an undercoating layer is formed. Accordingly, the undercoating layer enables an increased adhesiveness of the toner fixing layer to the base layer also producing a curling preventive effect after toner is fixed on the toner fixing layer of the electrophotographic recording medium.

Accordingly, when a high-resolution image such as a photograph is printed, having an undercoating layer formed can prevent the medium on which the image is printed from curling.

3. Test for Lightfastness

The test results associated with lightfastness of the electrophotographic recording media prepared in Examples 1 to 7 and Comparative Examples 1 to 6 are listed below in Table 3.

TABLE 3
Comparison of Lightfastness*

| | Examples | | | | | | |
|---|---|---|---|---|---|---|---|
| | Example 1 | Example 2 | Example 3 | Example 4 | Example 5 | Example 6 | Example 7 |
| Reduction | 5.5% | 4.5% | 4.0% | 6.0% | 5.5% | 7.0% | 5.5% |
| rate | | | | | | | |

| | Comparative Examples | | | | | |
|---|---|---|---|---|---|---|
| | Comparative | Comparative | Comparative | Comparative | Comparative | Comparative |
| | Example 1 | Example 2 | Example 3 | Example 4 | Example 5 | Example 6 |
| Reduction | 7.5% | 7.0% | 7.0% | 7.5% | 4.0% | 15.0% |
| rate | | | | | | |

*Lightfastness: An image is printed on a test specimen (e.g., 2.5 centimeter (cm) × 5 cm), and then left in a Ci-65 weatherometer (available from Atlas Electric Devices Co., IL. U.S.A.) for 50 hours, to measure how much optical density of cyan color is reduced.

Generally, when a whitening agent is added to a coating layer, the whiteness of a recording medium containing the coating layer can be increased, but the light resistance of a printed portion and unprinted portion thereof may be reduced, and thus, the lightfastness may also be reduced. However, when the whitening agent is added to an undercoating layer and exposed on a surface as illustrated by Example 6, the toner fixing layer coated on the undercoating layer can provide a light blocking effect. Accordingly, the electrophotographic recording medium prepared in Example 6 can exhibit relatively good lightfastness compared to when the whitening agent is added to the toner fixing layer, and is thus exposed on a surface as in Comparative Example 6.

Additionally, when a lightfastness enhancer is added to the electrophotographic recording medium prepared in Example 7, it may be possible to prevent the lightfastness from being reduced from the use of the whitening agent.

As described above, when an undercoating layer is interposed between a base layer and a toner fixing layer, it may be possible to produce an electrophotographic recording medium that has very good smoothness, glossiness, and print glossiness, that has a curling prevention effect, and that is capable of providing a clear image.

The foregoing embodiments and features are merely given by way of examples, and are not to be construed as limiting the full scope of the present disclosure, and many alternatives, modifications, and variations of the disclosed embodiments will be apparent to those skilled in the art. Aspects of the present disclosure can be readily applied to other types of apparatuses.

What is claimed is:

1. An electrophotographic recording medium, comprising:
a base layer;
an undercoating layer covering a surface of the base layer; and
a toner fixing layer covering the undercoating layer and defining an outer surface of the electrophotographic recording medium,
wherein the undercoating layer comprises one or more resins selected from a group consisting of an acryl resin, a polyurethane resin, a vinyl resin and a polyol resin.

2. The electrophotographic recording medium of claim 1, wherein the undercoating layer further comprises a hardener.

3. The electrophotographic recording medium of claim 1, wherein the toner fixing layer includes a filler and a binder resin.

4. The electrophotographic recording medium of claim 3, wherein the filler of the toner fixing layer comprises at least one selected from a group consisting of calcium carbonate, alumina, silica and titanium oxide, and has a mean volume diameter in a range of about 0.05 microns (μm) to about 2.5 μm.

5. The electrophotographic recording medium of claim 3, wherein the binder resin of the toner fixing layer comprises at least one selected from a group consisting of a polyvinyl alcohol, a polyvinyl pyrrolidone, a cellulose, a gelatin, a polyethylene oxide, an acryl, a polyester, a polyurethane, a latex and a quaternary ammonium-based copolymer.

6. The electrophotographic recording medium of claim 3, wherein the toner fixing layer includes the binder resin in an amount that ranges from about 5 to about 100 parts by weight based on 100 parts by weight of total solids in the toner fixing layer.

7. The electrophotographic recording medium of claim 1, wherein the undercoating layer has a thickness in a range of about 0.1 μm to about 5 μm.

8. The electrophotographic recording medium of claim 2, wherein the undercoating layer comprises about 80 to about 90 parts by weight of the resin based on 100 parts by weight of total solids in the undercoating layer and about 10 to about 20 parts by weight of the hardener based on 100 parts by weight of total solids in the undercoating layer.

9. The electrophotographic recording medium of claim 2, wherein the undercoating layer further includes an additive.

10. The electrophotographic recording medium of claim 9, wherein the additive comprises a whitening agent.

11. The electrophotographic recording medium of claim 1, wherein the base layer has a thickness in a range of about 50 μm to about 300 μm.

12. A method of manufacturing a recording medium, comprising:
providing a substrate;
preparing a coating material comprising one or more resins selected from a group consisting of an acryl resin, a polyurethane resin, a vinyl resin and a polyol resin;
coating at least one surface of the substrate with the coating material so as to form an undercoating layer; and
coating the undercoating layer with a composition that comprises a filler and binder resin to form a toner fixing layer covering the undercoating layer.

13. The method as set forth in claim 12, wherein the coating material comprises about 90 parts by weight of a polyol and about 10 parts by weight of a polyisocyanate.

14. The method as set forth in claim 12, wherein the coating material comprises an acrylic-based primer.

15. The method as set forth in claim 12, wherein the coating material may further comprise a whitening agent.

16. The method as set forth in claim 12, wherein the step of coating the coating material comprises coating the coating material in an amount that results in the undercoating layer having a thickness in a range of about 0.1 μm to about 5 μm.

17. The method as set forth in claim 12, wherein the composition comprises about 2 parts by weight of a polyvinyl alcohol, about 8 parts by weight of a latex, and about 90 parts by weight of a calcium carbonate.

18. The method as set forth in claim 12, wherein the coating material comprises about 95 parts by weight of a polyurethane and about 5 parts by weight of a polyurethane hardener.

19. The method as set forth in claim 12, wherein the coating material comprises about 95 parts by weight of a polyurethane, about 4.5 parts by weight of a polyurethane hardener, and about 0.5 parts by weight of a whitening agent.

20. The method as set forth in claim 12, wherein the substrate has a thickness in a range of about 50 μm to about 300 μm.
